(19) United States
(12) Patent Application Publication
(10) Pub. No.: US 2012/0154729 A1
(43) Pub. Date: Jun. 21, 2012

(54) DISPLAY DEVICE

(75) Inventor: Sang Rok LEE, Seoul (KR)

(73) Assignee: NEX-I SOLUTION. CO., LTD, Chungcheongbuk-Do (KR)

(21) Appl. No.: 13/332,336

(22) Filed: Dec. 20, 2011

(30) Foreign Application Priority Data
Dec. 21, 2010 (KR) 10-2010-0131796

(51) Int. Cl. G02F 1/1333; G02F 1/1343

(52) U.S. Cl. 349/138; 349/139

(57) ABSTRACT

Provided is a display device. The display device includes: a plurality of pixel electrodes disposed on one substrate; a common electrode disposed to face the pixel electrode on the other substrate facing the one substrate; a liquid crystal layer disposed between the one substrate and the other substrate; and a blocking electrode disposed on the one substrate, being insulated from the pixel electrode, wherein a blocking voltage is applied to the blocking electrode to allow the liquid crystal layer to be optically in an off-state.

### CROSS-REFERENCE TO RELATED APPLICATION

This application claims priority to Korean Patent Application No. 10-2010-0131796 filed on Dec. 21, 2010 and all the benefits accruing therefrom under 35 U.S.C. §119, the contents of which are incorporated by reference in their entirety.

### BACKGROUND

The present disclosure relates to a display device, and more particularly, to a display device to prevent leakage current and to maximize contrast ratio.

A liquid crystal display device includes a liquid crystal between a substrate having a plurality of pixel electrodes and a substrate having a common electrode and displays an image by modulating the brightness of light, which is accomplished by transmitting or reflecting the light incident from a light source based on a state of liquid crystal alignment caused by an alignment change of the liquid crystal according to the potential difference between the pixel electrodes and the common electrode. This liquid crystal display device is used as a display terminal such as a micro display unit and an Office Automation (OA) device and recently, its usage applications expand into a projector. Additionally, among the liquid crystal display devices, a drive circuit integrated liquid crystal display device including a drive circuit for driving a pixel electrode on a substrate with the pixel electrode is introduced. Furthermore, among the drive circuit integrated liquid display devices, a Liquid Crystal on Silicon (LCOS), where pixel electrodes and a drive circuit are formed on a semiconductor substrate not on an insulation substrate, is introduced.

In relation to the display device, a plurality of pixels is arranged in a matrix and a pixel selection device such as a transistor is prepared in each pixel so that a voltage of the pixel is determined. However, when a light incident from a light source or an ambient light passes through a space between the pixels and passes by around a transistor through various paths, leakage current could occur in the transistor due to photoconductive effect. This leakage current discharges electrical charge stored in a pixel or charges electrical charge to a pixel, so that image quality such as brightness and contrast may be deteriorated. Accordingly, a light blocking layer to reduce the leakage current in a pixel by blocking light passing through between pixels is formed between the pixels.

Moreover, when a liquid crystal is used in a device, due to a lateral electric field formed between pixels, liquid crystal molecules are tilted at the boundary of pixels so that light leakage occurs. That is, FIG. 1 is a view illustrating a state of a liquid crystal director when the center pixel maintains an optically on-state and two pixels at both sides thereof maintain an optically off-state. As shown in FIG. 1, at the boundary A of the center pixel and the two pixels at both sides thereof, liquid molecules are tilted due to a lateral electric field. According to the tilted liquid crystal molecules, an amount of light transmitted or reflected is changed. The light leakage between the pixels increase in proportion to the ratio of the distance between pixels to the cell gap of liquid crystal cells. Especially, if a lateral electric field effect is strong, it affects liquid crystal molecules in adjacent pixels so that it also affects the brightness of the corresponding pixels. FIG. 2 illustrates a change of light leakage occurring according to the ratio of the distance between pixels to the cell gap. This light leakage may deteriorate the contrast ratio of the display unit and may not reproduce an accurate image.

### SUMMARY

The present disclosure provides a display device to prevent a leakage current of a transistor occurring due to the light passing through between pixel electrodes and to prevent contrast ratio deterioration caused by a lateral electric field simultaneously.

The present disclosure also provides a display device having a blocking electrode to prevent a leakage current of a pixel due to a photoconductive effect and to prevent contrast deterioration caused by a lateral electric field by applying a predetermined voltage to the blocking electrode.

In accordance with an exemplary embodiment, a display device includes: an array of pixel electrodes disposed on one substrate; a common electrode disposed on another substrate facing the one substrate with the pixel array; a liquid crystal layer disposed between the one substrate with the pixel array and the substrate with common electrode; and a blocking electrode disposed on the substrate with the pixel array, being insulated from the pixel electrode, wherein a blocking voltage is applied to the blocking electrode to set the liquid crystal layer to an optically off-state.

The blocking electrode may be disposed in regions between the pixel electrodes.

The blocking electrode may be disposed in a region surrounding the array of the pixel electrodes.

The display unit may further include connection electrodes disposed in a region where the blocking electrode is not formed, to connect the pixel electrodes with a wiring pattern below the blocking electrode.

The blocking voltage may be applied, whose potential difference with respect to a common voltage applied to the common electrode is lower than a threshold voltage of the liquid crystal layer for normally black liquid crystal mode.

The blocking voltage and the common voltage may be the same for normally black liquid crystal mode.

The blocking voltage may be applied, considering a voltage division by the liquid crystal layer and insulation layers between the pixel electrode and the blocking electrode.

The blocking voltage may be inversed at each predetermined period according to the common voltage inversed at each predetermined period.

The display unit may further include a light blocking layer of at least one layer disposed between the blocking electrode and the pixel electrode.

An insulation layer may be disposed between the blocking electrode and the pixel electrode, the insulation layer is made of an opaque insulation material.

In accordance with another exemplary embodiment, a display device including: a display panel including a display unit where a plurality of pixels are arranged in a matrix, a row driver configured to supply a scanning signal to select a row of pixels, and a column driver configured to supply image data to the selected pixels; a display controller configured to supply the control signals to drive the display panel with the image data; and a voltage generator configured to generate a common voltage and a blocking voltage, wherein the display unit includes: a switching device configured to be driven in response to the scanning signal to deliver the image data; a storage device configured to receive the image data through the switching device and store the received image data; a pixel electrode configured to maintain a potential of the image data stored in the storage device; a common electrode facing the pixel electrode, where the common voltage is applied; a liquid crystal layer disposed between the pixel electrode and the common electrode; and a blocking electrode disposed below the pixel electrode, where the blocking voltage is applied, wherein the blocking voltage is applied to allow the liquid crystal layer to be in an optically off-state.

The blocking electrode may be disposed on the entire display unit except for the region where the array of pixels is placed.

The blocking voltage is applied, whose potential difference with respect to a common voltage applied to the common electrode is lower than a threshold voltage of the liquid crystal layer for normally black liquid crystal mode.

The blocking voltage and the common voltage may be the same for normally black liquid crystal mode.

The blocking voltage may be applied, considering a voltage division by the liquid crystal layer and insulation layers between the pixel electrode and the blocking electrode.

The blocking voltage may be inversed at each predetermined period according to the common voltage inversed at each predetermined period.

An insulation layer may be disposed between the blocking electrode and the pixel electrode, the insulation layer is made of an opaque insulation material.

### BRIEF DESCRIPTION OF THE DRAWINGS

Exemplary embodiments can be understood in more detail from the following description taken in conjunction with the accompanying drawings, in which:

FIG. 1 is a schematic view illustrating tilted liquid crystal molecules due to lateral electric field effect, occurring at the spacing between pixels in a related art display unit;

FIG. 2 is a graph illustrating a change of light leakage varying with respect to the ratio of a distance between pixels to a cell gap;

FIG. 3 is a block diagram illustrating a configuration of a display unit in accordance with an exemplary embodiment;

FIG. 4 is a schematic view of a pixel circuit in a display unit in accordance with an exemplary embodiment;

FIG. 5 is a plane view of a display unit in accordance with an exemplary embodiment;

FIG. 6 is a cross sectional view of a display unit in accordance with an exemplary embodiment;

FIG. 7 is a schematic view illustrating an alignment state of liquid crystal molecules according to the operation of a display unit in accordance with an exemplary embodiment;

FIG. 8 is a cross sectional view of a display unit in accordance with another exemplary embodiment; and

FIG. 9 is a cross sectional view of a display unit in accordance with still another exemplary embodiment.

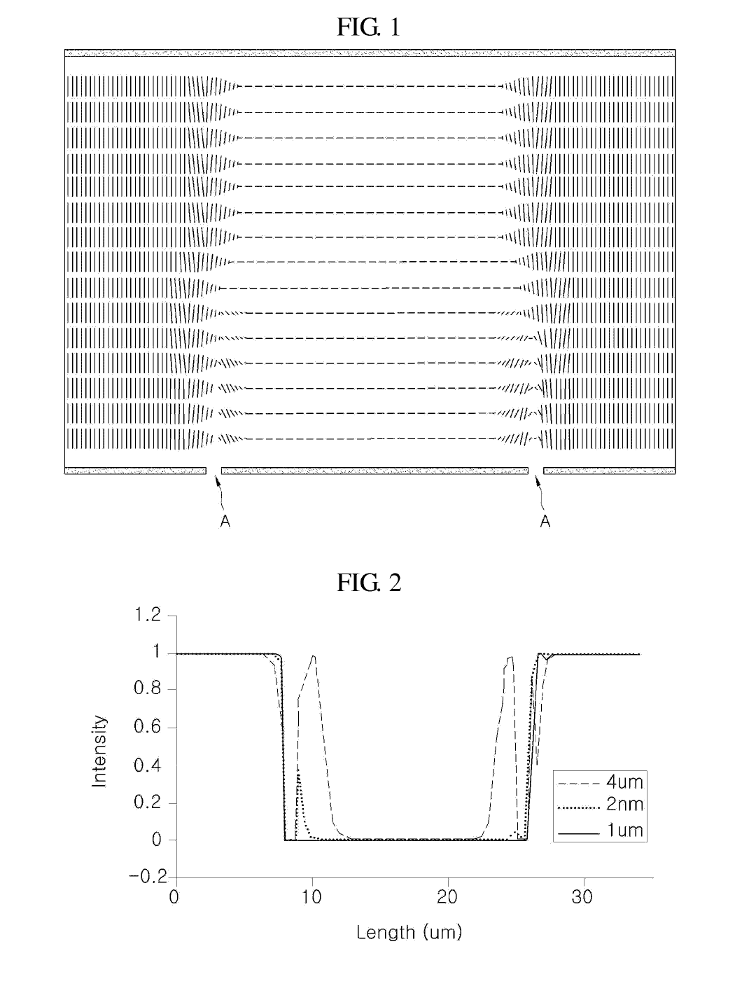

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

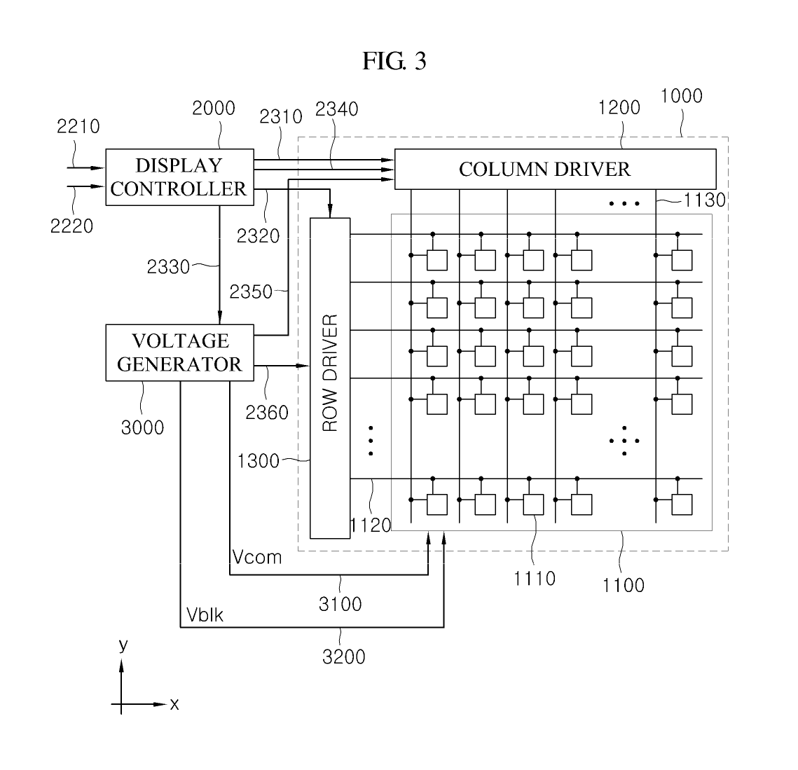

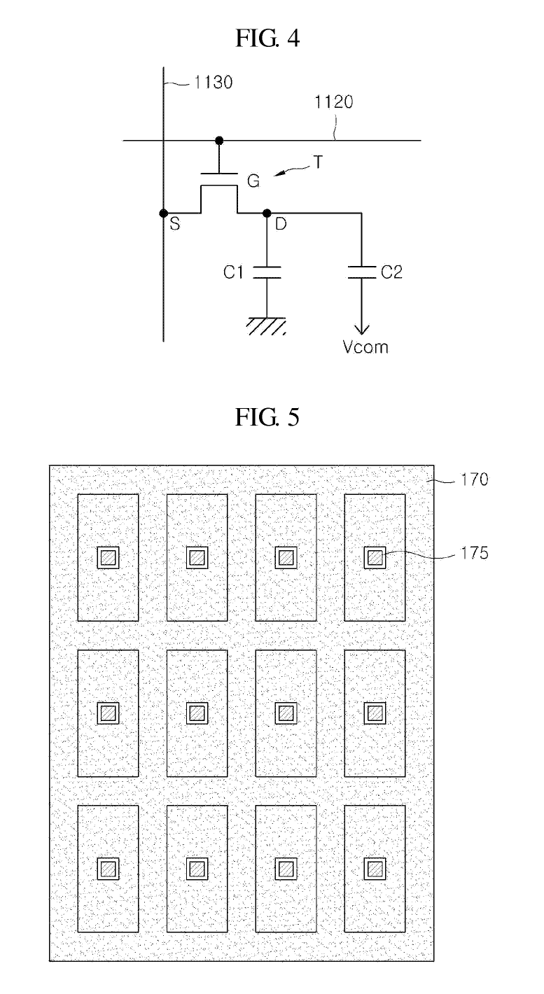

FIG. 3 is a schematic block diagram illustrating a display unit according to an embodiment. FIG. 4 is a schematic view of one pixel circuit.

Referring to FIG. 3, the display unit includes a display panel 1000 to display an image, a display controller 2000 to control the operation of the display panel 1000, and a voltage generator 3000 to generate various operating voltages necessary for driving the display panel 1000. Additionally, the display panel 1000 may include a display unit 1100, a column driver 1200, and a row driver 1300.

The display panel 1000 includes the display unit 1100 having a plurality of pixels 1110 arranged in a matrix, the column driver 1200 for supplying image data to the display unit 1100, and the row driver 1300 for selecting the pixel 1110 to display an image. Here, the display unit 1100, the column driver 1200, and the row driver 1300 may be installed on the same substrate. However, the display unit 1100 may be formed on one substrate and the column driver 1200 and the row driver 1300 may be connected to the display unit 1100 from the outside thereof. In the display unit 1100, a plurality of pixels 1110 are disposed in a matrix, which are respectively placed on the intersection regions of one direction (for example, a plurality of scanning signal lines 1120 extending in a parallel direction (X direction)) and the other direction (for example, a plurality of image signal lines 1130 extending in a vertical direction (Y direction)). The pixel 1110 is prepared with a pixel electrode and a common electrode facing each other and a liquid crystal layer therebetween. Once voltages are applied to the pixel electrode and the common electrode, a potential difference occurs between them and accordingly, an orientation of liquid molecules is changed and then the optical property of the liquid crystal layer is changed, thereby displaying an image. Additionally, each pixel 1110 includes at least one switching device T such as a transistor to select a pixel and a storage capacitor C1 to store image data. For example, as shown in FIG. 4, the transistor T is driven using a gate terminal G connected to the scanning signal line 1120, receives image data using a source terminal S connected to the image signal line 1130, and delivers the image data to the storage capacitor C1 using a drain terminal D connected to the storage capacitor C1. The storage capacitor C1 receives and stores the image data. Also, the capacitor C2 is a liquid crystal capacitor between the pixel 1110 and the common electrode. Moreover, the display panel 1000 includes blocking electrodes in the plurality of pixels 1110. The blocking electrode is provided below the pixel electrodes to block the light passing through the spacing between the pixels 1110 so that leakage current may be prevented. Furthermore, a blocking voltage Vblk is applied to the blocking electrode thereby forming a potential difference between the boundary between the pixels 1110 and the common electrode and accordingly, the liquid crystal in the spacing becomes an optically off-state, preventing the tilt of liquid crystal molecules caused by a lateral electric field. Therefore, contrast ratio deterioration by light leakage occurring at the spacing between the pixels 1110 may be prevented.

The display controller 2000 is connected to an external device (not shown) such as a personal computer through an external control signal line 2210. The display controller 2000 receives an external control signal from an external device and generates a control signal using the received signal to control the column driver 1200, the row driver 1300, and the voltage generator 3000. Moreover, the display controller 2000 is connected to a display signal line 2220 and thus receives display data from the external device. The display data are transmitted in a predetermined order to constitute an image displayed on the display panel 1000 and the display controller 2000 receives the display data. For example, starting with the pixel 1110 placed at the left side of the display panel 1000, a row of the pixel data is sequentially transmitted in the direction from left to right. Moreover, starting from the top to the bottom, the pixel data of each row are sequentially transmitted from the external device. The display controller 2000 generates image data based on the display data and provides the image data to the column driver 1200 in synchronization when the display panel 1000 displays an image. For this, the display controller 2000 delivers control signals to the column driver 1200 and the row driver 1300 through the control signal lines 2310 and 2320, and delivers the image data to the column driver 1200 through an image data transmission line 2340. That is, the column driver 1200 and the row driver 1300 are controlled and driven by the display controller 2000 and the image data are delivered to the display unit 1110 through the column driver 1200. Moreover, although it is shown that the image data transmission line 2340 is one in FIG. 3, a plurality of image data transmission lines 2340 may be used. Furthermore, the display controller 2000 delivers a control signal to the voltage generator 3000 through the control signal line 2330 to allow the voltage generator 3000 to generate various driving voltages.

The column driver 1200 is disposed around the display unit 1100, for example, at least at one side of the display unit 1100 in the vertical direction (Y direction). Additionally, the plurality of image signal lines 1130 extends from the column driver 1200 in the vertical direction (Y direction) in parallel. The image signal line 1130 is connected to the plurality of pixels 1110, thereby delivering the image signal to the pixel 1110. That is, the image data generated in the display controller 2000 are delivered to the column driver 1200 through the image data transmission line 2340 and the column driver 1200 generates an image signal using reference voltages delivered from the voltage generator 3000 through the image voltage line 2350 and delivers the generated image signal to the display unit 1110 through the image signal line 1130.

The row driver 1300 is disposed around the display unit 1100, for example, at least at one side of the horizontal direction (X direction). A plurality of scanning signal lines 1120 extends from the row driver 1300 in the horizontal (X direction) in parallel. The scanning signal line 1120 is connected to the plurality of pixels 1110 and through those, a scanning signal to drive a switching device such as a transistor in the pixel 1110 is delivered. That is, the control signal generated in the display controller 2000 is delivered to the row driver 1300 through the control signal transmission line 2320 and the row driver 1300 generates a scanning signal and the delivers the generated scanning signal to the display unit 1100 through the operating signal line 1120. Accordingly, this turns on or off switching devices in the selected pixels 1110.

The voltage generator 3000 generates various operating voltages necessary for driving the display unit according to a control signal delivered through the control signal line 2330, for example, an external power fed from the external power supply. The voltage generator 3000 generates an operating voltage for generating an operating signal necessary for selecting and driving the pixel 1110 and supplies the generated operating voltage to the row driver 1300 through the operating voltage line 2360. Additionally, the voltage generator 3000 generates an image voltage for generating an image signal and supplies the generated image voltage to the column driver 1200 through the image voltage line 2350. Moreover, the voltage generator 3000 generates a common voltage Vcom and then applies the generated common voltage Vcom to the common electrode of the pixel 1110 through the common voltage line 3100. This common voltage Vcom may be generated with various voltages that are a reference for generating a potential difference with respect to a pixel electrode according to operating conditions, for example, may be generated with the middle value (Vdd/2) of a power supply voltage. Additionally, the voltage generator 3000 generates a blocking voltage Vblk and applies the generated blocking voltage Vblk to the blocking electrode of the pixel 1110 through the blocking voltage line 3200. This blocking voltage Vblk may be generated with various voltages for allowing the liquid crystal layer to be optically in an off-state. That is, when a liquid crystal of a normal black mode is driven, the blocking voltage Vblk having a potential difference with respect to the common voltage Vcom lower than a threshold voltage of the liquid crystal layer is applied. For example, the blocking voltage Vblk may be generated with various voltages according to the common voltage Vcom. For example, when the common voltage Vcom is set with the middle value (Vdd/2) of the power voltage, the blocking voltage Vblk may be generated with the middle value (Vdd/2) of the power voltage. Moreover, since the blocking voltage Vblk is voltage-divided by insulation layers and the liquid crystal layer, between the pixel electrode and the blocking electrode, it may be compensated for allowing the liquid crystal layer to be in an optically off-state and then may be applied. By applying the blocking voltage Vblk to the blocking electrode of the pixel 1110, a light leakage phenomenon due to a lateral electric field occurring at the boundary of the pixels 1110 may be prevented, and accordingly, contrast may be improved.

Moreover, although a case that the blocking voltage Vblk is directly applied from the voltage generator 3000 to the display unit 1110 through the blocking voltage line 3200 is described in the embodiment, the blocking voltage Vblk may be applied to the pixel 1110 through the column driver 1200 or the row driver 1300. That is, since the blocking voltage Vblk is commonly applied to the all pixels 1110, it may not pass through the column driver 1200 or the row driver 1300 or may pass through one of them to be commonly applied to all pixels 1110 of the display unit 1100.

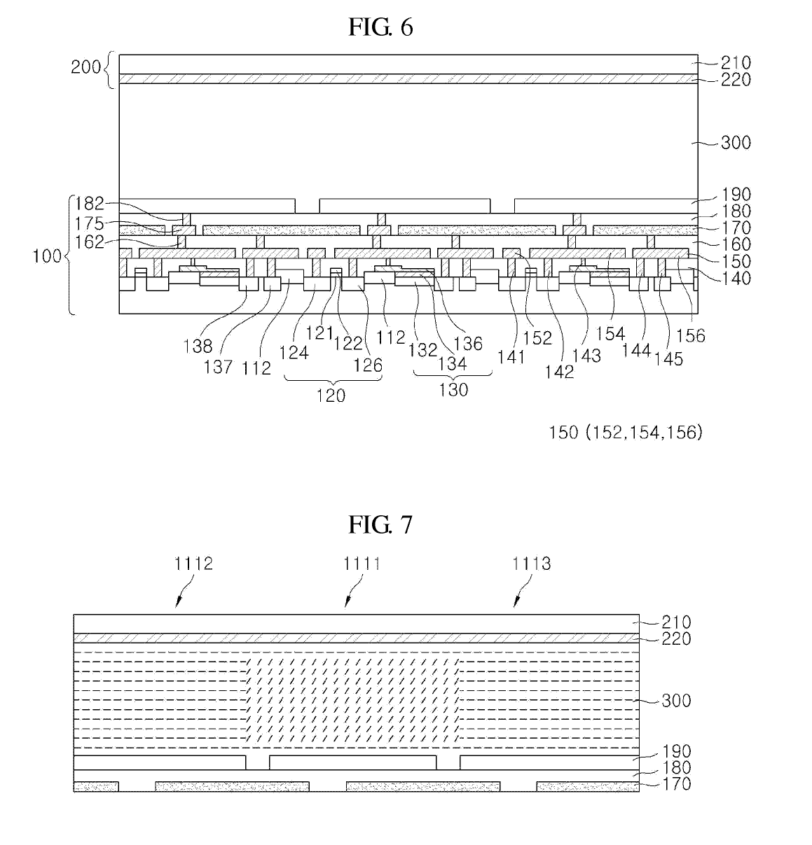

FIG. 5 is a plane view of a display unit in a display unit according to an embodiment. FIG. 6 is a cross-sectional view of adjacent three pixels. Here, a blocking electrode, a connection electrode, and a pixel electrode are mainly shown in FIG. 5 to describe their arrangements.

Referring to FIG. 5, the pixel of the display unit according to an embodiment includes a lower substrate 100, an upper substrate 200, and a liquid crystal layer 300 therebetween. Additionally, the lower substrate 100 includes a semiconductor substrate 110, a transistor 120 thereon, a storage capacitor 130, a blocking electrode 170, and a pixel electrode 190. The upper substrate 200 includes a transparent substrate 210 and a common electrode 220 thereon.

The semiconductor substrate 110 may use an n type or p type silicon (Si) substrate and besides those, may use a silicon oxide (SiO2) substrate, a silicon oxide (Si/SiO2) layer stacked substrate, and a polysilicon substrate. Moreover, a well region (not shown) is formed in the semiconductor substrate 110 and when an n type silicon substrate is used as the semiconductor substrate 110, a well region may be formed with an implanted p type impurity. This p type well region is formed at the predetermined depth in the semiconductor substrate 110. Moreover, a device isolation layer 112 may be formed on the semiconductor substrate 110 (that is, between one pixel and another pixel and between transistor 120 and the storage capacitor 130 in one pixel). Accordingly, the transistor 120 and the storage capacitor 130 may be separated and insulated from each other by the device isolation layer 112. The device isolation layer 112 may be formed in a predetermined region on the semiconductor substrate 110 by using an insulation material such as a silicon oxide (SiO2) or a silicon nitride (Si3N4). This device isolation layer 112 may be formed with a predetermined height from the predetermined depth of the semiconductor substrate 110.

The transistor 120 includes a gate electrode 122 on the semiconductor substrate 110 and a source region 124 and a drain region 126 on the semiconductor substrate 110 at both sides of the gate electrode 122. The gate electrode 122 may be formed with a single layer or a multi layer using a conductive material, for example, a single layer of a polysilicon or a stacked layer of polysilicon or tungsten silicide. The gate electrode 122 may be formed using a portion of the scanning signal line 1120 connected from the row driver 1200 to the pixel 1110. For example, a portion of the scanning signal line 1120 may partially protrude to each pixel region to form the gate electrode 122. Moreover, a gate insulation layer 121 is formed between the gate electrode 122 and the semiconductor substrate 110 to insulate the gate electrode 122 and the scanning signal line 1120 from the semiconductor substrate 110. This gate insulation layer 121 may be formed with a single layer or a plurality of layers using an insulation material such as silicon oxide or silicon nitride. Furthermore, the source region 124 and the drain region 126 may be formed through an ion implantation process on the semiconductor substrate at both sides of the gate electrode 122 and in the case of an NMOS transistor, an n type impurity is ion-implanted to form source and drain regions. That is, the source region 124 and the drain region 126 are formed in a predetermined region in the pixel 1110 and may be spaced from the gate electrode 122 therebetween. At this point, an impurity for forming the source region 124 and the drain region 126 may be injected with a concentration that is higher than that of an impurity in a well region in the semiconductor substrate 110.

The storage capacitor 130 includes a first electrode 132, a dielectric layer 134, and a second electrode 136. The first electrode 132 is formed by ion-implanting an n type impurity in the semiconductor substrate 110. At this point, the first electrode 132 may be formed with a concentration that is lower than an ion implantation concentration for forming the source region 124 and the drain region 126 of the transistor 120. Additionally, a capacitance of the storage capacitor 130 is proportional to an area of the first electrode 132. Since the storage capacitor 130 needs to charge a potential according to image data and maintain the stored potential during one frame, the first electrode 132 may be formed with an area that is capable of charging a potential according to the maximum value of the image data and maintaining the charged potential during one frame. The dielectric layer 134 is formed on the semiconductor substrate 1210 with the first electrode 132, and is typically formed with a smaller size than the first electrode 132. This dielectric layer 134 may be formed with an ONO structure where silicon oxide, silicon nitride, and silicon oxide are stacked or may be formed with a single layer of silicon oxide or silicon nitride. Besides that, the dielectric layer 134 may be formed with various dielectric materials. Moreover, the second electrode 136 is formed on the dielectric layer 134 to at least partially overlap the first electrode. Here, the second electrode 136 may be formed on the dielectric layer 134 and the device isolation layer 112 to completely overlap the first electrode 132 and may partially overlap the device isolation layer 112. This second electrode 136 may be formed using a conductive material such as polysilicon and metal. For example, the second electrode 136 may be formed with the same material as the scanning signal line 1120 and the gate electrode 112. In this case, the scanning signal line 1120, the gate electrode 122, and the second electrode 136 may be simultaneously formed. Moreover, an n type impurity region 137 and a p type impurity region 138 may be formed between the first electrode 132 of the storage capacitor 130 and the device isolation layer 112 adjacent thereto. The n type impurity region 137 is formed to connect to the first electrode 132 and the n type impurity region 137 and p type impurity region 138 are formed being spaced a predetermined interval from each other.

At least one transistor 120 and one storage capacitor 130 are formed in the one pixel 1110 and the adjacent pixel 1110 is separated by the device isolation layer 112. The transistor 120 and the storage capacitor 130 in the one pixel 1110 are separated also. Additionally, the transistor 120 and the storage capacitor 130 are alternately formed with the device isolation layer 112 therebetween.

A first insulation layer 140 is formed on the semiconductor substrate 110 having the transistor 120 and the storage capacitor 130. The first insulation layer 140 may be formed using an insulation material such as silicon oxide and silicon nitride, and may be formed with a single layer or a plurality of layers. Additionally, a plurality of contact holes 141, 142, 143, 144, and 145 exposing a predetermined region of the transistor 120 and the storage capacitor 130 are formed in the first insulation layer 140. That is, the contact holes 141 and 142 are formed to expose the source region 124 and the drain region 126 of the transistor 120 and the contact hole 143 is formed to expose the second electrode of the storage capacitor 130. Moreover, the contact holes 144 and 145 are formed to expose the n type impurity region 137 and the p type impurity region 138, respectively.

A wiring layer 150 is formed on the first insulation layer 140 and includes a plurality of wiring patterns 152, 154, and 156. The wiring layer 150 supplies image data to the transistor 120 and serves to connect the transistor 120 with the storage capacitor 130. That is, the first wiring pattern 152 is formed to fill the contact hole 141, which is formed to expose the source region 124 in the first insulation layer 140, to connect to the source region 124. Additionally, the second wiring pattern 154 fills the contact holes 142 and 143, which is formed to expose the source region 126 and the second electrode 136 of the capacitor 130 in the first insulation layer 140 to connect them. Accordingly, the drain region 124 and the second electrode 136 are connected through the second wiring pattern 154. Additionally, the third wiring pattern 156 fills the contact holes 144 and 145, which are formed to expose the n type impurity region 137 and the p type impurity region 138 in the first insulation layer 140, to connect them. Accordingly, the n type impurity region 137 and the p type impurity region 138 are connected through the third wiring pattern 156. This wiring layer 150 may be the image signal line 1130 extending from the column driver 1300 to the pixel 1110 or may be separately formed from the image signal line 1130. That is, the first wiring pattern 152 is connected to the column driver 1300 to serve as the image signal line 1130 for delivering image data and the second and third wiring patterns 154 and 156 are formed being diverged from the first wiring pattern 152. The second wiring pattern 154 serves to connect the drain region 126 and the storage capacitor 130 with the pixel electrode 190 and the third wiring pattern 156 serves to connect the n and p type impurity regions 136 and 137 with the blocking electrode 170. Moreover, this wiring layer 150 may be formed of a conductive material including a metal material such as aluminum.

A second insulation layer 160 is formed on the wiring layer 150. The second insulation layer 160 may be formed using an insulation material such as silicon oxide and silicon nitride, and may be formed with a single layer or a plurality of layers. Additionally, a plurality of contact holes 162 and 164 exposing a predetermined region of the wiring layer 150 are formed in the second insulation layer 160. That is, the contact holes 162 and 164 are formed to expose the second and third wiring patterns 154 and 156 of the one pixel 1110. The contact hole 162 may be formed to be in a position corresponding to the device isolation layer 1121 between the transistor 120 and the storage capacitor 130. Additionally, the contact hole 164 may be formed in a region corresponding to a region between the n type impurity region 137 and the p type impurity region 138.

The blocking electrode 170 and the connection electrode 175 are formed on the second insulation layer 160. The connection electrode 175 is formed in a predetermined region of the pixel 1110 and the blocking electrode 170 is formed in all regions of the display unit 1100 except for the region having the connection electrode 175 and the region spaced from the connection electrode 175. The blocking electrode 170 is formed by filling the contact hole 164 exposing the third electrode pattern 156 and the connection electrode 175 is formed by filling the contact hole 162 exposing the second electrode pattern 154. Since the blocking electrode 170 is formed on an entire region of the display unit 110 except for the region having the connection electrode 175, the light incident to the bottom of the pixel 1110, i.e., the transistor 120, may be blocked by the blocking electrode 170. Additionally, since a predetermined voltage, i.e., a blocking voltage Vblk, is applied to the blocking electrode 170, light leakage due to the tilt of the liquid crystal directors caused by a lateral electric field in the pixel 110 and the boundary region between the pixels 1110 may be prevented. Accordingly, contrast deterioration may be resolved. That is, the blocking voltage Vblk is applied to the blocking electrode 170, so that a potential difference with respect to the common electrode 220 allows the liquid crystals in the spacing between the pixels 1110 to fix in an optically off-state. Accordingly, a liquid crystal layer between the pixels 1110 becomes in a black state so that entire brightness is somewhat reduced but the contrast of the display unit is maximized. As a result, the quality of an image may be improved. Moreover, the connection electrode 175 serves to connect the transistor 120 and the storage capacitor 130 with the pixel electrode 190 that is formed later.

A third insulation layer 180 is formed on the second insulation layer 160 having the blocking electrode 170 and the connection electrode 175. The third insulation layer 180 may be formed using an insulation material such as silicon oxide and silicon nitride, and may be formed with a single layer or a plurality of layers. Moreover, a plurality of contact holes 182 exposing the connection electrode 175 are formed in the third insulation layer 180.

The pixel electrode 190 is formed on the third insulation layer 180. The pixel electrode 190 is formed in a region corresponding to the pixel 1110 and may be formed to partially overlap a region between the pixels 1110. The pixel electrode 190 may be formed by filling the contact hole 182 in the third insulation layer 180. That is, the pixel electrode 190 is connected to the second wiring pattern 154 through the connection electrode 175 and as a result, the transistor 120 and the storage capacitor 130 are connected. Accordingly, the pixel electrode 190 may maintain a potential of the image data stored in the storage capacitor 130 through the transistor 120. The pixel electrode 190 may serve to reflect the light incident from the upper substrate 200. This pixel electrode 190 may be formed of a material having reflective and conductive characteristics such as aluminum.

Moreover, the upper substrate 200 facing the lower substrate 100 includes a transparent substrate 210 and a common electrode 220 on the transparent substrate 210. The transparent substrate 210 may use a plastic substrate or a glass substrate. Moreover, the common electrode 220 may be formed of a transparent conducive material such as indium tin oxide (ITO) or indium zinc oxide (IZO). The common electrode 220 and the pixel electrode 190 on the lower substrate form electric field in the liquid crystal layer 300.

A method of driving the display unit according to the embodiment will be described as follows.

First, at least one pixel 1110 in the intersection regions of one scanning signal line 1120 (where a scanning signal is enabled and delivered) and one image signal 1130 (where image data are enabled and delivered) is selected to display an image. A scanning signal is delivered through the scanning signal line 1120 to turn on the gate electrode 122 of the transistor 120 and the image data are delivered to the source region 124 of the transistor 120 through the image signal line 1130. At this point, since the transistor 120 is turned on, charges transfer from the source region 124 to the drain region 126. Accordingly, the image data are delivered to the drain region 126 and are stored in the storage capacitor 130 connected to the drain region 126. That is, the storage capacitor 130 charges a potential according to the image data.

The image data stored in the storage capacitor 130 are delivered to the pixel electrode 190 connected thereto and the pixel electrode 190 maintains a potential according to the image data. At this point, a common voltage Vcom is applied to the common electrode 220 of the upper substrate 200. Accordingly, according to a potential difference between the pixel electrode 190 and the common electrode 220, the alignment of the liquid crystal molecules is rearranged and the light incident to the upper substrate 200 is reflected by the pixel electrode 190 and the brightness of the reflected light is modulated according to an arrangement of the liquid crystal molecules. If a case of a vertically aligned liquid crystal mode is described, as shown in FIG. 7, a potential difference between the common electrode 220 and the pixel electrode 190, which is lower than a threshold voltage of the liquid crystal (i.e., a voltage at which the orientation alignment of the liquid crystal starts to change), is applied to allow the center pixel 1111 to operate in an optically off-state, so that image information displayed on the pixel 1111 is related to a black state. Additionally, a potential difference between the common electrode 220 and the pixel electrode 290 is applied to completely drive the liquid crystal to allow the pixels 1112 and 1113 at both sides of the pixel 1111 to be in an optically on-state, so that image information displayed on the pixels 1112 and 1113 is related to a white state.

At this point, while light incident to the upper substrate 200 passes through the liquid crystal layer 300 and reaches the lower substrate 100, the light passing through the liquid crystal layer 300 may be reflected by the pixel electrode 190 and also penetrates into the bottom through the spacing between the pixel electrodes 190. At this point, since the blocking electrode 170 is formed around the spacing between the pixel electrodes 190, the light penetrating into the bottom due to the blocking electrode 170 and flowing into the transistor 120 may be prevented. Accordingly, leakage current of the transistor 120 may be prevented.

Moreover, the blocking voltage Vblk is applied to the blocking electrode 170. The blocking voltage Vblk is applied with a potential that allows a potential difference of the blocking electrode 170 and the common electrode 220 to drive the liquid crystals in the spacing between the pixels 1110 in an optically off-state. That is, the voltage is applied so that the blocking voltage Vblk and the common voltage Vcom have no potential difference. For example, the blocking voltage Vblk and the common voltage Vcom are the same. Since no potential difference occurs at the spacing between the center pixel 1111 and the pixels 1112 and 1113 at both sides thereof by applying the blocking voltage Vblk, the tilt of liquid crystal molecules due to a lateral electric field does not occur. Accordingly, light leakage due to the tilt of liquid crystal molecules between the pixels may be prevented and accordingly, contrast deterioration may be resolved. However, once the blocking voltage Vblk is applied to the blocking electrode 170, the liquid crystal layer 300 between the center pixel 1111 and the pixels 1112 and 1113 becomes a black state so that total brightness is somewhat reduced but contrast of the display unit is maximized. As a result, the quality of an image to be displayed may be increased. Moreover, when the blocking voltage Vblk is applied to the blocking electrode 170, because of the voltage distribution of the liquid crystal layer 300 and the third insulation layer 180, an actual potential difference at both ends of the liquid crystal layer 300 is lower than that at the blocking electrode 170 and the common electrode 220. Therefore, a level of the voltage applied to the blocking electrode 170 may be adjusted to switch the liquid crystal layer 300 to an optically off-state and then applied.

In addition, it is assumed in the embodiment that a mode of a liquid crystal is a vertically aligned mode, but all liquid crystal modes (for example, an electrically controller birefringence (ECB) mode, an optically compensated bend (OCB) mode, and a twisted nematic (TN) mode besides the vertically aligned mode) representing an on-state, an off-state, or a medium gray-state by adjusting a voltage applied between the common electrode and the pixel electrode may be used.

Additionally, the liquid crystal is driven through various methods such as frame inversion, column inversion, and row inversion. At this point, it is important to apply a voltage to the blocking electrode to switch the liquid crystal between the pixels to an optically off-state even if various methods are used. In the case of the frame inversion, since a voltage of the common electrode is inversed in each frame, a voltage applied to the blocking electrode is inversed in each frame and applied so that the liquid crystal between the pixels becomes an optically off-state in all frames. In the cases of the column inversion and the row inversion, based on the common voltage constantly applied to the common electrode, a blocking voltage applied to the blocking electrode is inversed at each frame such that the voltage difference between the blocking voltage and the common voltage does not exceed the threshold voltage of liquid crystal for the vertically aligned liquid crystal mode. A blocking voltage which is identical to the common voltage may be applied to keep the liquid crystal layer in the spacing between pixels at an optically off state. As a whole, a driving waveform of the liquid crystal between pixel electrodes is DC-balanced waveform and the liquid crystal layer is driven in an optically off-state.

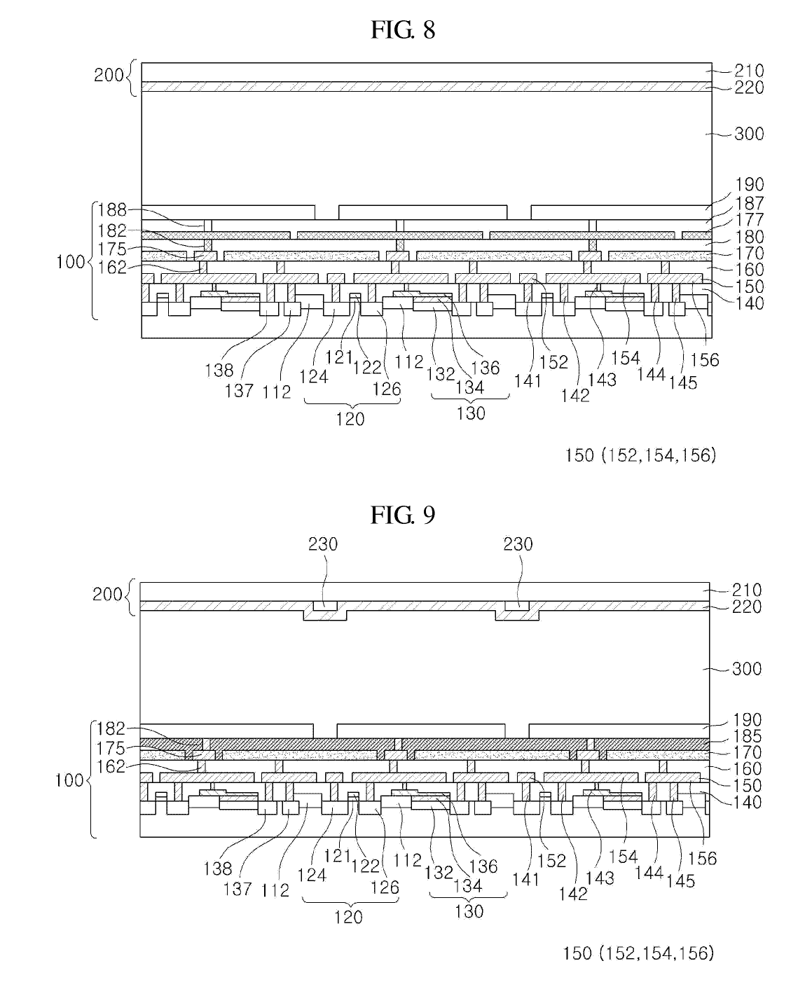

Moreover, by the forming of the blocking electrode 170 and at least one light blocking layer, the light flowing into the transistor 120 may be more effectively prevented, and accordingly, leakage current occurrence may be minimized. For example, as shown in FIG. 8, a light blocking layer 177 may be further formed between the blocking electrode 170 and the pixel electrode 190 and also, a fourth insulation layer 187 may be further formed. The light blocking layer 177 may be formed to cover a region between the pixel electrodes 190 and a region without the blocking electrode 170, i.e., a region having the connection electrode 175. Additionally, the light blocking layer 177 may be formed to fill the contact hole 188 in the fourth insulation layer 187 to connect the connection electrode 175 with the pixel electrode 190.

Additionally, without the forming of the additional light blocking layer, an opaque insulation layer 185 formed between the blocking electrode 170 and the pixel electrode 190 may serve as a an additional light blocking layer. That is, since an insulation layer formed between the blocking electrode 170 and the pixel electrode 190 to insulate them from each other is formed of the opaque insulation layer 185, it may serve as an insulation layer and a light blocking layer simultaneously. This opaque insulation layer 185 may be manufactured by adding a black pigment to an insulation material. The black pigment may use carbon black or titanium oxide, which is mainly used for the black matrix 230. Moreover, the black matrix 230 may be further formed on the upper substrate 200. The black matrix 230 is formed between the pixel regions and prevents light from leaking into a region besides the pixel region and light interference between adjacent pixel regions. The black matrix 230 may be formed outside of pixel array region to prevent light from leaking into substrate. The black matrix 230 may be formed of a photosensitive organic material added with the black pigment. The black pigment may use carbon black or titanium oxide.

According to an embodiment, in order to block the light incident through between pixel electrodes, a blocking electrode is formed and blocking voltage is applied to the blocking electrode. The blocking voltage is applied to allow a liquid crystal layer between a common electrode and a blocking electrode to be optically in an off-state. Additionally, a light blocking layer may be further formed between the blocking electrode and the pixel electrode.

According to an embodiment, since the light incident between the pixel electrodes is blocked by forming a blocking electrode below a pixel electrode, leakage current of a transistor may be prevented.

Moreover, by applying a blocking voltage with no potential difference between a common electrode and a blocking electrode, the tilt of liquid crystal molecules between pixel electrodes may be prevented. As a result, light leakage may be prevented and accordingly contrast may be improved.

Although the display device has been described with reference to the specific embodiments, it is not limited thereto. Therefore, it will be readily understood by those skilled in the art that various modifications and changes can be made thereto without departing from the spirit and scope of the present invention defined by the appended claims.

What is claimed is:

1. A display unit comprising:
a plurality of pixel electrodes disposed on one substrate;
a common electrode disposed to face the pixel electrodes on the other substrate facing the one substrate;
a liquid crystal layer disposed between the one substrate and the other substrate; and
a blocking electrode disposed on the one substrate, being insulated from the pixel electrode,
wherein a blocking voltage is applied to the blocking electrode to allow the liquid crystal layer to be optically in an off-state.

2. The display unit of claim 1, wherein the blocking electrode is disposed in a region between the pixel electrodes.

3. The display unit of claim 2, wherein the blocking electrode is disposed in a region outside of the pixel electrodes.

4. The display unit of claim 3, further comprising a connection electrode disposed in a region where the blocking electrode is not formed, to connect the pixel electrode with a wiring pattern below the blocking electrode.

5. The display unit of claim 1, wherein the blocking voltage is applied, whose potential difference with respect to a common voltage applied to the common electrode is adjusted to set the liquid crystal layer to an optically off-state.

6. The display unit of claim 5, wherein the blocking voltage and the common voltage are the same for vertically aligned liquid crystal mode.

7. The display unit of claim 5, wherein the blocking voltage is applied, which considers a voltage division by the liquid crystal layer and insulation layers between the pixel electrode and the blocking electrode.

8. The display unit of claim 1, wherein the blocking voltage is inversed at each predetermined period according to the common voltage inversed at each predetermined period to supply a DC balanced blocking voltage waveform.

9. The display unit of claim 1, further comprising a light blocking layer of at least one layer disposed between the blocking electrode and the pixel electrode.

10. The display unit of claim 1, wherein an insulation layer is disposed between the blocking electrode and the pixel electrode, the insulation layer being formed of an opaque insulation material.

11. A display device comprising:
a display panel comprising a display unit where a plurality of pixels are arranged in a matrix, a row driver configured to supply a scanning signal to select a row of pixels, and a column driver configured to supply image data to the selected pixels;
a display controller configured to supply control signals and the image data to drive the column and row driver; and
a voltage generator configured to generate a common voltage and a blocking voltage,
wherein the display unit comprises:
a switching device configured to be driven in response to the scanning signal to deliver the image data;
a storage device configured to receive the image data through the switching device and store the received image data;
a pixel electrode configured to maintain a potential of the image data stored in the storage device;
a common electrode facing the pixel electrode, where the common voltage is applied;
a liquid crystal layer disposed between the pixel electrode and the common electrode; and
a blocking electrode disposed below the pixel electrode, where the blocking voltage is applied,
wherein the blocking voltage is applied to allow the liquid crystal layer to be in an optically off-state.

12. The display unit of claim 12, wherein the blocking electrode is disposed in a region between the pixel electrodes.

13. The display unit of claim 12, wherein the blocking electrode is disposed in a region outside of the pixel electrodes.

14. The display unit of claim 11, further comprising a connection electrode disposed in a region where the blocking electrode is not formed, to connect the pixel electrode with a wiring pattern below the blocking electrode.

15. The display unit of claim 11, wherein the blocking voltage is applied, whose potential difference with respect to a common voltage applied to the common electrode is adjusted to set liquid crystal layer to an optically off-state.

16. The display unit of claim 15, wherein the blocking voltage and the common voltage are the same for vertically aligned liquid crystal mode.

17. The display unit of claim 15, wherein the blocking voltage is applied, which considers a voltage division by the liquid crystal layer and insulation layers between the pixel electrode and the blocking electrode.

18. The display unit of claim 11, wherein the blocking voltage is inversed at each predetermined period according to the common voltage inversed at each predetermined period to supply a DC balanced blocking voltage waveform.

19. The display unit of claim 11, further comprising a light blocking layer of at least one layer disposed between the blocking electrode and the pixel electrode.

20. The display unit of claim 11, wherein an insulation layer is disposed between the blocking electrode and the pixel electrode, the insulation layer being formed of an opaque insulation material.
